(19) United States
(12) Patent Application Publication
(10) Pub. No.: US 2006/0111187 A1
(43) Pub. Date: May 25, 2006

(54) Method for communications and game device

(76) Inventor: Yoshio Miyazaki, Kanagawa (JP)

Correspondence Address: KATTEN MUCHIN ROSENMAN LLP, 575 MADISON AVENUE, NEW YORK, NY, 10022-2585, US

(21) Appl. No.: 11/260,677

(22) Filed: Oct. 27, 2005

Related U.S. Application Data
(63) Continuation of application No. PCT/JP04/05362, filed on Apr. 15, 2004.

(30) Foreign Application Priority Data
Apr. 30, 2003 (JP) 2003-125649

(51) Int. Cl. A63F 13/00; A63F 9/24

(52) U.S. Cl. 463/40; 463/31

(57) ABSTRACT

According to a game system, the communication period between a radio controller serving as a slave and a game device serving as a master can be made variable in a power saving mode. In a scene which requires a certain real-time level, the communication period is shortened, while in a scene which does not require a certain real-time level, the communication period is elongated. This variability of communication period as appropriate in the power saving mode can reduce power consumption without degrading the game characteristic.

### CROSS-REFERENCE TO RELATED APPLICATION

This application is a continuation of International Application PCT/JP04/005362 filed on Apr. 15, 2004, pending at the time of filing of this continuation application and claims priority from Japanese Patent Application 2003-125649 filed on Apr. 30, 2003, the contents of which are herein wholly incorporated by reference.

### BACKGROUND OF THE INVENTION

1. Field of the Invention

The present invention relates to communications technologies, and more particularly to a technology for implementing radio communications between a master and a slave.

2. Description of the Related Art

Conventionally, a game device and a controller for the game device were typically connected to each other via a cable. However, a game system has been recently suggested which provides a radio connection between a game device and its controller. The employment of the radio controller has made it possible for the user to take any posture in playing games.

A hand-held radio controller is battery-powered. Thus, if the battery is consumed in a short period of time, there will arise a need for frequently recharging the battery, thereby providing degraded ease of use. To extend the duration of availability of the radio controller, it would be possible to lower the transmission power; however, this would result in another problem of reducing the communication distance.

### SUMMARY OF THE INVENTION

In an embodiment of the present invention, a communication method for communicating information between a master and a slave may implement efficient wireless connectivity between a master and a slave, in particular, which realize reduction of power requirements of radio terminals. The communication method may allow for variably setting communication periods.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a view showing the overall configuration of a game system according to an embodiment of the present invention;

FIG. 2 is a view showing a Bluetooth state transition;

FIG. 3 is a view showing a communication scheme in a sniff mode;

FIG. 4 is a view showing the configuration of a game device;

FIG. 5 is a table showing the relation between a game genre and the presence or absence of a low delay requirement;

FIG. 6 is a table showing the relation between a game title and the presence or absence of a low delay requirement;

FIG. 7 is a view showing the configuration of a radio controller; and

FIG. 8(a) is a view showing a communication scheme with a sniff period having a one frame length (16.7 ms), FIG. 8(b) being a view showing a communication scheme with a sniff period having two frame lengths (33.3 ms).

### DETAILED DESCRIPTION OF THE INVENTION

An aspect of the present invention relates to a method for communicating information between a master and a slave, the information being reflected on an image to be displayed on a display. In the method according to this aspect, a communication period is variably set with respect to a frame rate of the image. The communication period allowed to be set as appropriate enables achieving of power savings and controlling of the response speed of the slave. The method according to this aspect may be preferably used in a power saving mode, thereby realizing greater power savings.

The master and the slave may be wirelessly connected to each other, and the slave can be a battery-powered hand-held terminal. In the communication method according to this aspect, the communication period may be set according to the type of the image to be displayed. Furthermore, the communication period may be set based on a delay that is permitted in reflecting the information sent from the slave on the image, thereby reducing power requirements of the slave.

Another aspect of the present invention relates to a method for wirelessly communicating information between a game device and a controller for the game device, the information being reflected on a game image to be displayed on a display. In the method according to this aspect, a communication period is variably set with respect to a frame rate of the game image. The communication period allowed to be set as appropriate enables achieving of power savings and controlling of the response speed of the controller. The method according to this aspect may be preferably used in a power saving mode, thereby realizing greater power savings.

In the method according to this aspect, the communication period may be set according to the type of the game image, the title of the game, or the genre of the game. The communication period may be set based on a delay that is permitted in reflecting the information sent from the game device controller on the game image, thereby reducing power requirements of the game device controller.

The communication period may be changed between during a setting mode of a game and during a play of the game. A default value for the communication period may be preset, and the communication period may be determined by selecting from among a mode in which the default value is used for the communication period and a mode in which the communication period is variably set. Alternatively, the communication period may be set based on an instruction from a user, in the case of which the user is allowed to set the response speed of a game character.

Another aspect of the present invention relates to a game device for wirelessly communicating information with a controller for the game device, the information being reflected on a game image to be displayed on a display. In the game device according to this aspect, a communication period is variably set with respect to a frame rate of the game image. The communication period allowed to be set as appropriate enables achieving of power savings and controlling of the response speed of the controller.

Another aspect of the present invention provides a program for allowing a computer to realize a function for variably setting a communication period with respect to an image frame rate, and a function for using the communication period having been set to communicate information being reflected on an image to be displayed on a display.

Another aspect of the present invention provides a computer readable recording medium having stored a program for allowing a computer to realize a function for variably setting a communication period with respect to an image frame rate, and a function for using the communication period having been set to communicate information being reflected on an image to be displayed on a display.

Incidentally, any combinations of the foregoing components, and any conversions of expressions of the present invention from/into methods, apparatuses, systems, recording media, computer programs, and the like are also intended to constitute applicable aspects of the present invention.

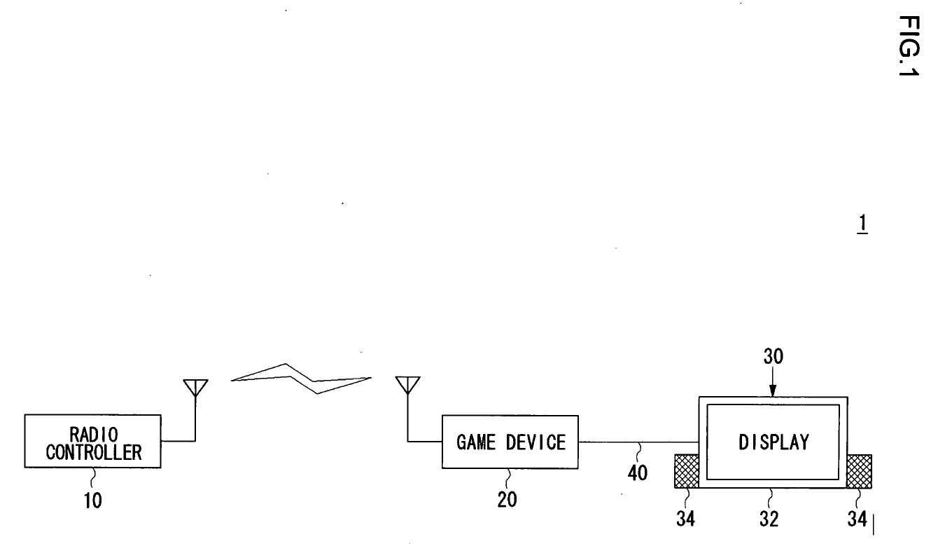

FIG. 1 is a view showing the overall configuration of a game system 1 according to an embodiment of the present invention. The game system 1 according to this embodiment includes, as a user input interface, a radio controller 10 which performs radio communications with a game device 20. The game device 20 has a radio communication function. An output device 30 includes a display 32 and a speaker 34, where the output device 30 receives AV (Audio Visual) data of a game from the game device 20 over a network 40, allowing the game video image to be displayed on the display 32 and the sound to be delivered through the speaker 34.

The game device 20 and the output device 30 may be connected to each other wirelessly or by cables. For example, the network 40, which connects between the game device 20 and the output device 30, may take the form of a home network made up of network (LAN) cables or a wireless LAN. The game device 20 and the output device 30 connected wirelessly to each other could be laid out relatively freely, when compared with those wired such as by cables, thereby allowing the user to enjoy games without being limited to a particular location.

The radio controller 10 and the game device 20 may establish a radio connection therebetween using Bluetooth (registered trademark). The game device 20 may be configured to enable radio connections to a plurality of radio controllers 10. That is, in the game system 1, point to multi-point connections may also be made between the game device 20 and the plurality of radio controllers 10. The game device 20 serves as a parent device or a master, while the radio controller 10 serves as a slave. Hereinafter, take such a case as an example where the Bluetooth is employed as the communications protocol and the radio controller 10 serves as a Bluetooth terminal.

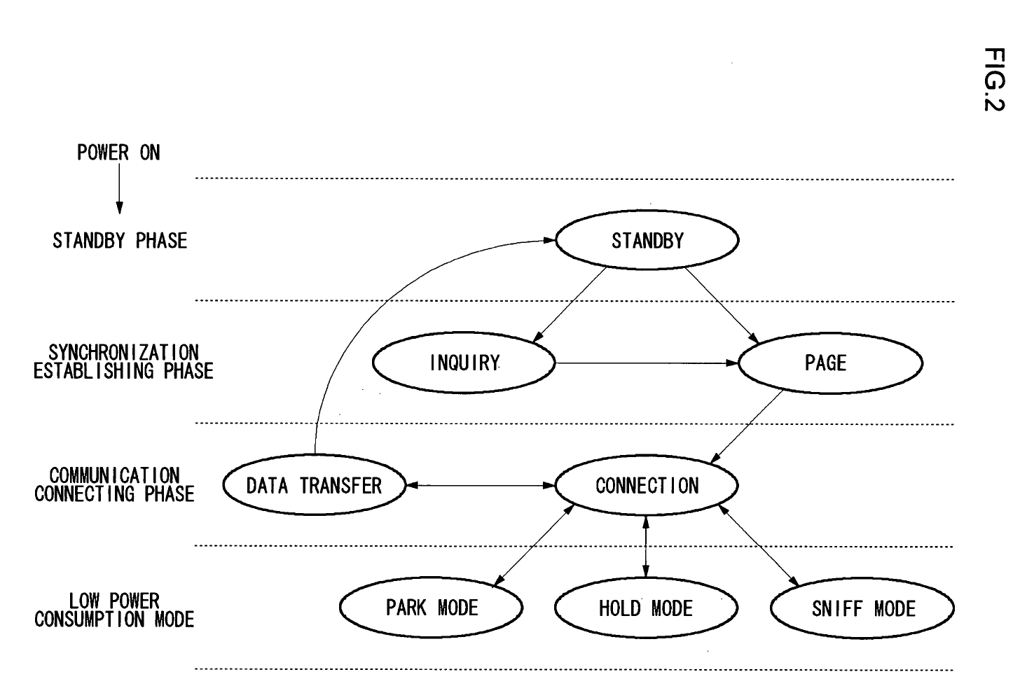

FIG. 2 is a view showing a Bluetooth state transition. As shown, the state of the Bluetooth terminal can be divided into a standby phase, a synchronization establishing phase, a communication connecting phase, and a low power consumption mode.

Immediately after the radio controller 10 has been powered on or disconnected from a communication link, the radio controller 10 enters a “standby” state. In the “standby” state, the radio controller 10 neither transmits nor receives data.

In the synchronization establishing phase, there are two states available: an “inquiry” state in which the game device 20 sends an inquiry to surrounding terminal devices including the radio controller 10, and a “page” state in which the game device 20 recognizes and pages the radio controller 10. In the “inquiry” state, the game device 20 broadcasts an IQ (inquiry) packet for nearby terminal devices. Upon reception of the IQ packet, the radio controller 10 transmits an FHS (Frequency Hop Synchronization) packet, which contains a Bluetooth address and clock information, back to the game device 20. In the communications at this point in time, since a frequency hopping pattern has not yet been agreed upon between the game device 20 and the radio controller 10, a fixed hopping pattern is used which is defined for dedicated use with inquiry.

In the “page” state, the game device 20 receives an FHS packet from the radio controller 10 to know what radio controllers 10 are present, and then transmits an ID packet to a particular radio controller 10. Upon reception of a response to the ID packet from the particular radio controller 10, the game device 20 transmits the FHS packet to the radio controller 10 indicating its own address and clock to the radio controller 10. This makes it possible for the game device 20 and the radio controller 10 to have the same hopping pattern in common.

A page will cause a piconet to be formed between the radio controller 10 and the game device 20, which enter a “connected” state. A piconet means a network which will be formed in an ad hoc fashion between Bluetooth terminals when they are brought close to each other. One piconet can include up to eight Bluetooth terminals. In one piconet, the game device 20 can serve as a master that is connected to up to seven radio controllers 10. In the “connected” state, a control packet is communicated to set a communication link, thereby enabling “data transfer.” When a data transfer is completed and the communication link is disconnected, the radio controller 10 is placed back in the standby state.

When retransmitting after having once performed communications and then entered the standby state, the radio controller 10 can transition to the page state without making an inquiry. An inquiry is made when the game device 20 does not know what terminal devices are present around itself. An inquiry is a broadcast for all slaves from the game device 20, and each terminal responds to it. In the page state, the game device 20 already knows the presence of the radio controller 10 and thus talks to each slave point to point to establish synchronization within the piconet. Once synchronization is established within the piconet, no broadcast needs to be carried out to restart communications even when the radio controller 10 is in the standby state after having completed the previous communications. For example, a broadcast may take 10 seconds or more to carry out. Thus, an inquiry may be eliminated to thereby reduce the time for establishing a connection. As used herein, the expression “establishing synchronization within a piconet” means that a Bluetooth address and clock information are exchanged between the game device 20 and the radio controller 10 to synchronize the hopping pattern.

The radio controller 10, serving as a slave, can transition from the connected state to three types of low power consumption modes: a “park mode,” “hold mode,” and “sniff mode.” On the other hand, the game device 20 serving as a master can transition from the connected state to the “hold mode.”

The radio controller 10 in the “park mode” is kept synchronous to the piconet, i.e., the hopping pattern and the master clock. However, the radio controller 10 cannot exchange packets with the game device 20. The radio controller 10 in this state receives data from the game device 20 at regular time intervals (beacon cycles), and thus can immediately participate in the piconet if required. In the park mode, the radio controller 10 returns a slave identifier assigned by the game device 20, i.e., a three-bit address (1 to 7) given to the radio controller 10 being connected back to the game device 20 for the time being. Accordingly, if there is no slave identifier available, the radio controller 10 cannot participate in the piconet even when it wants to take part in the piconet again. Conversely, the game device 20 provides an 8-bit park slave identifier to the radio controller 10 which is going to enter the park mode. The game device 20 can manage up to 255 parked terminal devices, and allows only a required radio controller 10 to participate in the piconet whenever necessary.

While being kept synchronous to the piconet, the radio controller 10 in the “hold mode” and the game device 20 do not communicate with each other during a certain period of time having been set (hold time) but restart communications after the hold time.

The radio controller 10 in the “sniff mode” can reduce power consumption by performing communications only within a predetermined period of time in a sniff period and not in the other period of time. The sniff period needs to be agreed upon in advance between the game device 20 and the radio controller 10.

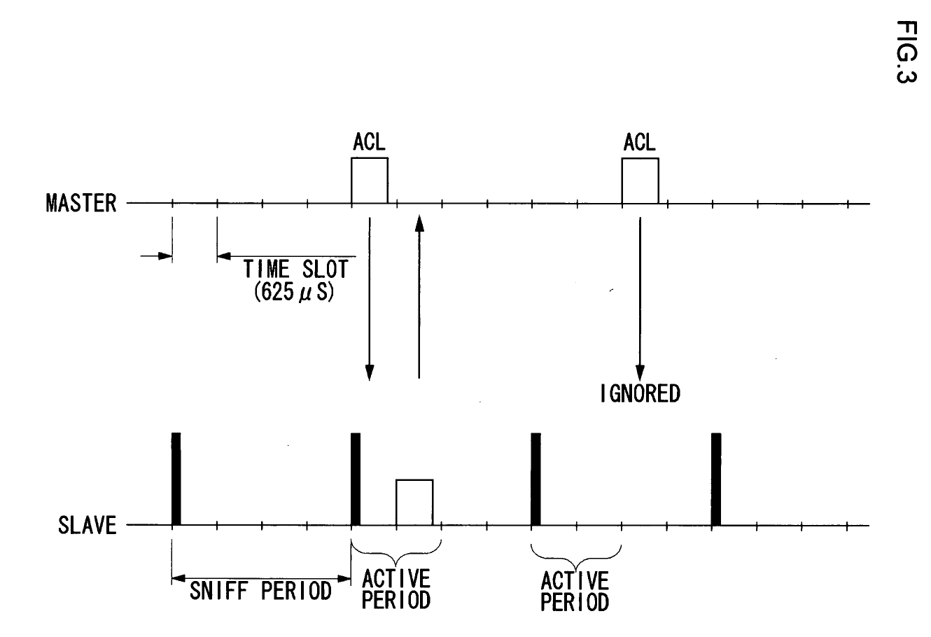

FIG. 3 shows a communication scheme in the sniff mode. In this embodiment, the game device 20 serves as a mater and the radio controller 10 serves as a slave. Between the master and the slave, established is an asynchronous packet exchanged communication link called an ACL (Asynchronous Connection Less) link. As shown, a setting of 625 μs is provided to a time slot.

In the sniff mode, an active period in a sniff period, i.e., a period of time available for communications between the master and the slave is predetermined. In the active period, the slave can wait for a packet (hereinafter referred to as an ACL packet) that is transmitted from the master for a duration of a predetermined number of time slots, or two time slots in this example and then respond thereto. Outside the active period, the slave cannot perform communications, thus neither receiving any ACL packets from the master nor transmitting packets from the slave. Accordingly, the slave ignores those ACL packets that are sent from the master outside the active period.

The sniff period and the active period are set on the slave side via LMP (Link Manager Protocol). A control packet (LMP_Sniff_req) which instructs a transition to the sniff mode is communicated between the master and the slave to thereby provide this setting. The LMP_Sniff_req packet includes communication parameters such as the starting time of a sniff slot, a sniff period, and an active period. The LMP_Sniff_req continues to be communicated until both the master and the slave reach an agreement or disagreement on the communication parameters. The master may issue a request to the slave for the transition to the sniff mode, or the slave may issue the request to the master for the transition to the sniff mode. When the agreement is reached between the master and the slave, the master now knows the sniff period and the active period. Accordingly, to send the ACL packet to the slave in the sniff mode, the master can transmit it in agreement with the active period in the sniff period. In the following description, it is assumed that the master transmits the ACL packet at the starting point of each sniff period. In the example of FIG. 3, an active period is set as a duration of time from the starting point of the sniff period until two time slots elapse. However, the starting point of the active period and the number of time slots may be set arbitrarily in a sniff period.

The radio controller 10 serving as a slave receives a control instruction from a user. This control instruction is transmitted to the master in response to the reception of the ACL packet from the master. More specifically, the control instruction from the user is made, for example, by the user depressing a predetermined control button provided on the radio controller 10.

When the user enters a control instruction to the slave in the active period in a sniff period, the slave will transmit the control instruction to the master during the same active period. On the other hand, when the user provides a control instruction outside the active period, the slave holds the control instruction to transmit it during the next active period. That is, in this case, a delay in time up to one sniff period will occur in transmitting to the master.

From the foregoing, it can be said that a game with real-time requirement is unfavorably provided with a setting of a long sniff period and thus an elongated maximum delay time. On the other hand, it is favorable to set a long sniff period for a game with no real-time requirement, thereby realizing power savings. In view of this point, the game system 1 according to this embodiment enables a communication period to be freely changed in a sniff period, i.e., in a power saving mode. Thus, the communication period in the power saving mode can be set as appropriate, thereby reducing power requirements of the radio controller 10 as circumstances demand.

From the viewpoint of the level of real time, games can be largely divided into two groups: one group of games with a high level of real-time requirement and the other group of games with a low level of real-time requirement. For example, the games with a high level of real-time requirement include a battle game or a racing simulation game which progresses so rapidly that a control entry by the user needs to be instantaneously reflected on an output such as the display 32. The games with a low level of real-time requirement include a match game such as Shougi (Japanese chess) or Mahjongg or a RPG (Role-Playing Game) which progresses comparatively slowly.

The game with a high level of real-time requirement requires the control instruction from the user to be reflected instantaneously on the game image displayed on the display 32. The response speed of the radio controller 10 is thus preferably high. Accordingly, in this case, the communication period is preferably set to be shorter with respect to the frame rate of the game image. On the other hand, the game with a low level of real-time requirement can somewhat tolerate a low response speed of the radio controller 10. Accordingly, in this case, the communication period is preferably set to be longer with respect to the frame rate in order to reduce power consumption.

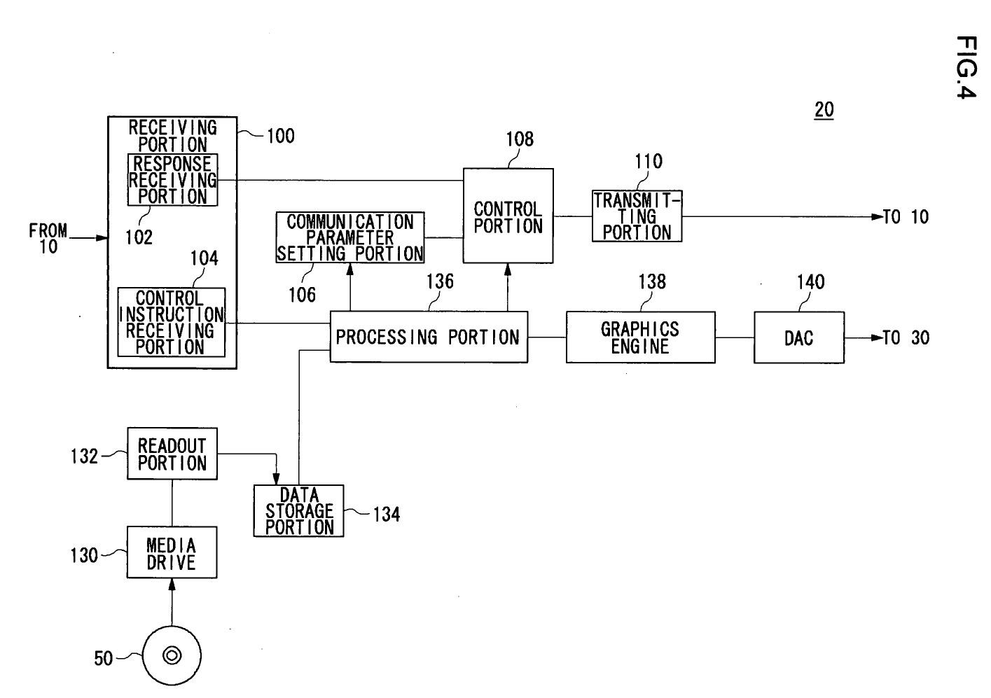

FIG. 4 shows the configuration of the game device 20 according to this embodiment. The game device 20 includes a receiving portion 100, a communication parameter setting portion 106, a control portion 108, a transmitting portion 110, a media drive 130, a readout portion 132, a data storage portion 134, a processing portion 136, a graphics engine 138, and a D-A converter 140. The receiving portion 100 has a response receiving portion 102 and a control instruction receiving portion 104. Each function of the game device 20 is implemented with a CPU, a memory, a program loaded in the memory and the like. Here, illustrated are the functional blocks that are implemented with these components working together. The program may be incorporated in the game device 20 or stored on a recording medium to be supplied externally. Accordingly, it will be understood by those skilled in the art that these functional blocks can be realized in a variety of forms, i.e., only in hardware, only in software, or in a combination thereof.

A medium 50 having game data stored is inserted into the media drive 130. For example, the medium 50 includes a CD-ROM or DVD, which stores game data such as the AV data of game scenes or game programs. The game programs may be stored in the medium 50 in such a form that can be executed directly by the processing portion 136 or decoded to be then executed by the processing portion 136. The media drive 130 drives the medium 50, while the readout portion 132 reads the game data stored on the medium 50 for delivery to the data storage portion 134. The processing portion 136 then executes the game data read.

The control instruction receiving portion 104 receives a game control instruction from the radio controller 10 and sends it to the processing portion 136. The game control instruction is information to be reflected on the game image to be displayed on the display 32. The processing portion 136 processes the game data according to the control instruction by the user, while the graphics engine 138 creates the AV data of the game in accordance with the game data having been processed by the processing portion 136. The AV data of the game created in digital form is converted into an analog signal at the D-A converter 140 and then supplied to the output device 30. This allows the image and sound, on which the game control instruction from the user is reflected, to be output on the display 32 and through the speaker 34, respectively. In the case of the radio controller 10 having a vibration function, the processing portion 136 sends, in response to the control instruction by the user, a signal for vibrating the radio controller 10 to the control portion 108, while the transmitting portion 110 transmits the signal received from the control portion 108 to the radio controller 10.

The communication parameter setting portion 106 sets communication parameters, such as the starting time of a sniff mode, a sniff period, and an active period, with respect to the frame rate of the game image. In this embodiment, instruction information for defining the communication parameters is preset, associated with the AV data, in the game data stored on the medium 50. For example, the instruction information may be information regarding the type of a game image or the title of a game or the information for identifying the genre of a game or a scene of a game. Furthermore, the instruction information may be a direct representation of the feature of the AV data itself, e.g., an image having quick motions. The instruction information may also be information indicating the presence or absence of real-time requirement derived from the feature of the AV data, i.e., the presence or absence of a low delay requirement. The processing portion 136 extracts the instruction information preset on the medium 50 and then sends it to the communication parameter setting portion 106. The communication parameter setting portion 106 analyzes the instruction information to determine the communication parameters to be set. This setting is sent to the transmitting portion 110 via the control portion 108, and then the transmitting portion 110 transmits to the radio controller 10 a control packet (LMP_Sniff_req) for instructing a transition to the sniff mode.

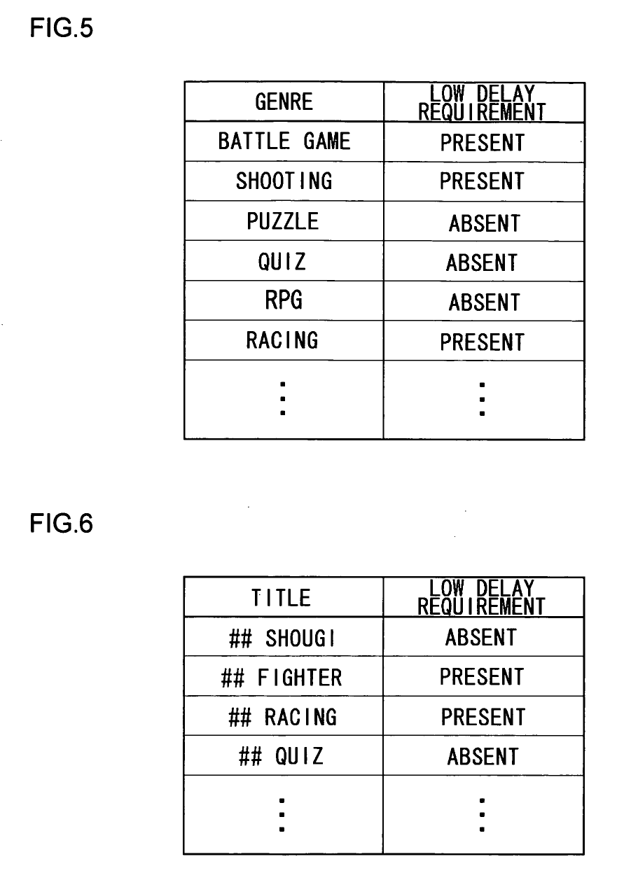

FIG. 5 is a table showing the relation between a game genre and the presence or absence of a low delay requirement. When the instruction information sent from the processing portion 136 is indicative of a game genre, the communication parameter setting portion 106 refers to the table shown in FIG. 5 to determine the presence or absence of the low delay requirement for the AV data and then set communication parameters. At this time, the communication parameter setting portion 106 sets the communication parameters including a sniff period based on the delay that is permitted in reflecting the information sent from the radio controller 10 on the game image. More specifically, in the presence of the low delay requirement, the sniff period is set to be shorter, whereas in the absence of the low delay requirement, the sniff period is set to be longer. This makes it possible to efficiently reduce the power requirements of the radio controller 10 without impairing the continuity of the game.

FIG. 6 is a table showing the relation between a game title and the presence or absence of a low delay requirement. When the instruction information sent from the processing portion 136 is indicative of a game title, the communication parameter setting portion 106 refers to the table shown in FIG. 6 to determine the presence or absence of the low delay requirement for the AV data and then set communication parameters. Alternatively, it is also acceptable to utilize a table that relates the title to the genre, in the case of which the communication parameter setting portion 106 may classify the genre from the title, and then based on the genre, determine the presence or absence of the low delay requirement with reference to the table shown in FIG. 5 and then set communication parameters. The communication parameter setting portion 106 sets the communication parameters including a sniff period based on the delay that is permitted in reflecting the information sent from the radio controller 10 on the game image. As described above, in the presence of the low delay requirement, the sniff period is set to be shorter, whereas in the absence of the low delay requirement, the sniff period is set to be longer. This makes it possible to efficiently reduce the power requirements of the radio controller 10 without impairing the continuity of the game.

In the aforementioned example, the communication parameters are set for the entire game; however, the communication parameters may also be set according to the type of the game image, more specifically, a scene of the game. In general, during the play of even one game, some scenes may require and the other may not require a certain real-time level. In a battle game, a certain real-time level is required during a battle using characters, whereas not being required in setting the characters before the battle or in a scene after the battle has ended. It is thus possible to pre-store in the game data the instruction information indicative of the presence or absence of the low delay requirement according to such game scenes. The communication parameter setting portion 106 may determine, based on the instruction information preset for each scene, whether the scene requires a low delay, and then set communication parameters. For example, the communication period may be adaptively changed between during a character setting mode of a game and during a play of the game, thereby reducing the power requirements of the radio controller 10 while flexibly satisfying the requirement for the response speed to a game scene.

In the presence of a low delay requirement, the radio controller 10 and the game device 20 may preferably communicate with each other once or more in one frame (16.7 ms). This makes it possible to reflect the user control with the radio controller 10 on the game in real time. On the other hand, in the absence of a low delay requirement, the radio controller 10 and the game device 20 may preferably communicate with each other as frequently as once in a plurality of frames, for example, once in two frames (33.3 ms) or once in three frames (50 ms). This makes it possible to further reduce the power requirements of the radio controller 10. As such, the communication parameter setting portion 106 can variably set the communication period with respect to the frame rate of a game image and thereby control the frequency at which the control instruction from the user is reflected on the game image.

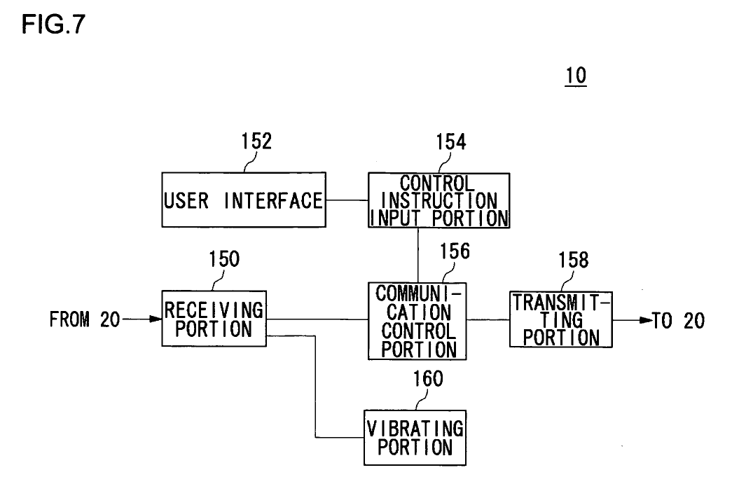

FIG. 7 is a view showing the configuration of the radio controller 10 according to this embodiment. The radio controller 10 includes a receiving portion 150, a user interface 152, a control instruction input portion 154, a communication control portion 156, a transmitting portion 158, and a vibrating portion 160. Each function of the radio controller 10 is implemented with a CPU, a memory, a program loaded in the memory and the like. Here, illustrated are the functional blocks that are implemented with these components working together. The program may be incorporated in the radio controller 10 or stored on a recording medium to be supplied externally. Accordingly, it will be understood by those skilled in the art that these functional blocks can be realized in a variety of forms, i.e., only in hardware, only in software, or in a combination thereof. When the program is supplied externally, the radio controller 10 includes an interface for receiving the program.

The user interface 152, configured to allow a control entry by the user, includes control keys or control buttons. The user utilizes the user interface 152 to provide various settings on the game setting screen or provide control to the characters during the play of a game. The control instruction input portion 154 receives the control instruction entered via the user interface 152 and then conveys it to the communication control portion 156.

The receiving portion 150 receives a transmitted signal from the game device 20. Upon reception of a vibration instruction from the game device 20 to drive the vibrating function of the radio controller 10, the vibration instruction is sent to the vibrating portion 160 to rotate a motor provided in the vibrating portion 160 and thereby vibrate the vibrating portion 160.

Upon reception of a control packet from the game device 20 to transition to a sniff mode, the receiving portion 150 sends it to the communication control portion 156. The communication control portion 156 refers to the communication parameters contained in the control packet. Having agreed upon the conditions for the communication parameters such as the communication period, the communication control portion 156 creates a permission signal indicative of the agreement. The transmitting portion 158 transmits the permission signal to the game device 20.

Referring back to FIG. 4, the response receiving portion 102 of the game device 20 receives the permission signal and sends it to the control portion 108. Having recognized that the radio controller 10 has agreed upon the communication parameter, the control portion 108 stores the communication parameters to utilize them in the subsequent communications during the sniff mode. The control portion 108 creates an ACL packet in the starting slot of each sniff period for transmission by the transmitting portion 110.

Referring back to FIG. 7, once the communication parameters are determined in the sniff mode, the communication control portion 156 stops communications outside the active period of the sniff period. Stopping the communications will enable reducing of the power requirements of the radio controller 10. As already described above, the communication parameters such as a sniff period are determined based on the information regarding the type of a game image or the title of a game or the information for identifying the genre of a game or the scene of a game. According to the game system 1 of this embodiment, the sniff period is set based on the delay that is permitted in reflecting the control instruction from the user on the game image. Accordingly, setting the sniff period to be longer would make it possible to efficiently reduce the amount of power used by the radio controller 10.

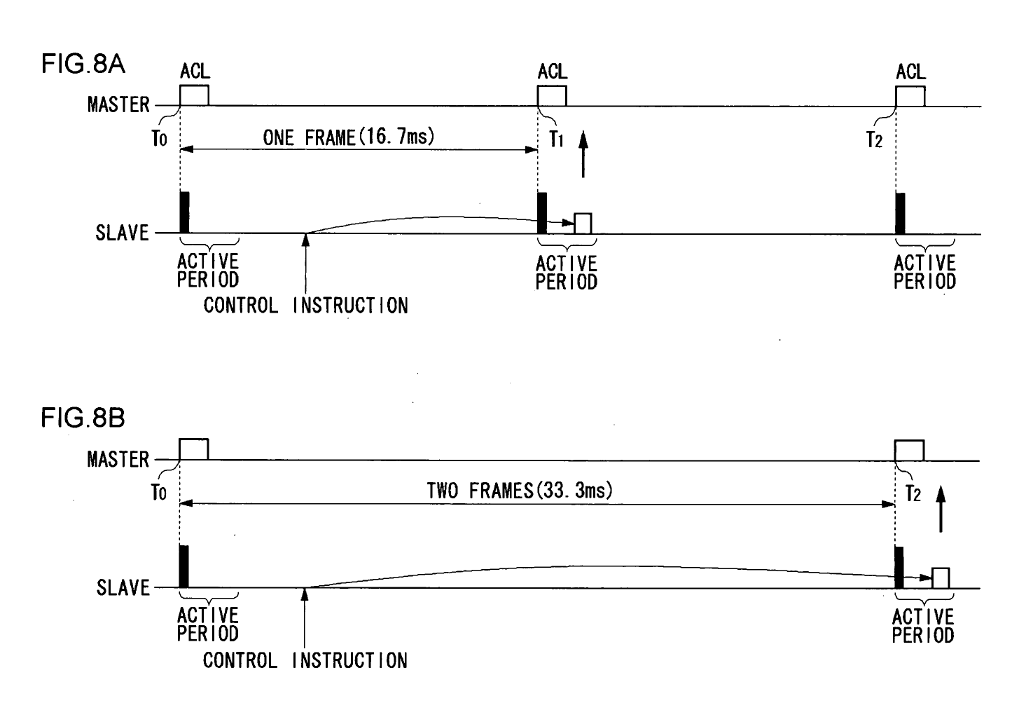

FIG. 8(a) is a view showing a communication scheme with a sniff period having a one frame length (16.7 ms). Here, in the sniff period from time T0 to T1, suppose that the user provides a control instruction outside the active period. In this case, the control instruction is to be transmitted from the radio controller 10 to the game device 20 in the active period in the next sniff period from time T1 to T2. Accordingly, the delay in transmission of the control instruction is up to one frame length.

FIG. 8(b) is a view showing a communication scheme with a sniff period having two frame lengths (33.3 ms). Here, in the sniff period from time T0 to T2, suppose that the user provides a control instruction outside the active period. In this case, the control instruction is to be transmitted from the radio controller 10 to the game device 20 in the active period in the next sniff period starting from time T2. Accordingly, the delay in transmission of the control instruction is up to two frame lengths.

From the foregoing, it can be seen that setting the sniff period to be shorter would reduce the delay in transmission time, whereas setting the sniff period to be longer would increase the delay in transmission time. According to the game system 1 of this embodiment, the sniff period is set based on the determination of whether or not a low delay requirement is present. This makes it possible to maintain the battery for the radio controller 10 for a long duration without causing any unusual feeling to the user during the play of a game. It is also made possible to reduce the battery capacity per unit time, thereby reducing the radio controller 10 in size and weight.

In the foregoing, the present invention has been described with reference to the embodiment. It will be understood by those skilled in the art that the embodiment is only illustrative, and a variety of modifications can be made to a combination of each of the components and each of the processing steps without departing from the scope of the present invention. This embodiment has been described with reference to the Bluetooth as the radio communication protocol; however, this embodiment is not limited thereto, but may also be applicable using other communications protocols.

In the embodiment, such an example has been described in which the game device 20 transmits to the radio controller 10 a request for a transition to the sniff mode. However, in another example, it is also possible to transmit the transition request from the radio controller 10 to the game device 20. In this case, the user sets the communication parameters such as a sniff period via the user interface 152 (see FIG. 7), and the communication control portion 156 transmits a control packet (LMP_Sniff_req) to the game device 20. In the game device 20 (see FIG. 4), the control instruction receiving portion 104 receives the control packet, and the processing portion 136 conveys the control packet to the communication parameter setting portion 106. When the communication parameter setting portion 106 permits the communication parameters contained in the control packet, the transmitting portion 110 transmits the permission signal created in the control portion 108 to the radio controller 10. The above procedure allows the user to set the communication parameter.

The effect of the user setting the communication parameter will be recognized in the response speed of a character appearing during the play of a game. That is, setting the sniff period to be longer would cause the character to respond less quickly, whereas setting the communication period to be shorter would cause the character to respond more quickly. For example, suppose that in a battle mode of a battle game, a beginner and an advanced player play the game. In this case, the response speed of the character controlled by the advanced player may be slowed down, so that the beginner and the advanced player can enjoy the game on an equality with each other. As such, the user can spontaneously set the communication period, thereby allowing for setting the response speed of game characters, and in particular, significantly improving the attractiveness of the game in a battle mode.

Furthermore, the communication parameter setting portion 106 may preset a default value for the communication period, i.e., for the sniff period. The communication parameter setting portion 106 may also select from among a mode in which the default value is used for the communication period and a mode in which the communication period is variably set, in order to set the communication period. In the embodiment, the communication parameter setting portion 106 is configured to set the communication parameter based on the instruction information indicative of the title of a game or the like. However, for example, when no instruction information is present, the default value can be set to the sniff period, thereby reducing the power requirements of the radio controller 10.

What is claimed is:

1. A method for wirelessly communicating information between a game device and a controller for the game device, the information being reflected on a game image to be displayed on a display, wherein
a communication period is variably set with respect to a level of real-time requirement.

2. The communication method according to claim 1, wherein the communication period is variably set with respect to a frame rate of the game image, the frame rate serving as the level of real-time requirement.

3. The communication method according to claim 1, wherein the communication period is set during a power saving mode.

4. The communication method according to claim 1, wherein the communication period is set according to a type of the game image, a title of the game, or a genre of the game.

5. The communication method according to claim 1, wherein the communication period is set based on a delay that is permitted in reflecting the information sent from the game device controller on the game image, thereby reducing power requirements of the game device controller.

6. The communication method according to claim 1, wherein the communication period is changed between during a setting mode of a game and during a play of the game.

7. The communication method according to claim 1, wherein a default value for the communication period is preset, and the communication period is determined by selecting from among a mode in which the default value is used for the communication period and a mode in which the communication period is variably set.

8. The communication method according to claim 1, wherein the communication period is set based on an instruction from a user.

9. The communication method according to claim 8, wherein the communication period is set, thereby allowing the user to set a response speed of a game character.

10. A communication method for communicating information between a master and a slave, the information being reflected on an image to be displayed on a display, wherein
a communication period is variably set with respect to a frame rate of the image.

11. The communication method according to claim 10, wherein the communication period is set during a power saving mode.

12. The communication method according to claim 10, wherein the master and the slave are wirelessly connected to each other, and the slave is a battery-powered portable terminal.

13. The communication method according to claim 10, wherein the communication period is set according to a type of the image to be displayed.

14. The communication method according to claim 10, wherein the communication period is set based on a delay that is permitted in reflecting the information sent from the slave on the image, thereby reducing power requirements of the slave.

15. A game device for wirelessly communicating information with a controller for the game device, the information being reflected on a game image to be displayed on a display, wherein
a communication period is variably set with respect to a frame rate of the game image.

16. The game device according to claim 15, wherein the communication period is set in a power saving mode.

17. The game device according to claim 15, wherein the communication period is set based on an instruction from a user.

18. The game device according to claim 17, wherein the communication period is set, thereby allowing the user to set a response speed of a game character.

19. A program for allowing a computer to realize
a function for variably setting a communication period with respect to an image frame rate, and
a function for using the communication period having been set to communicate information being reflected on an image to be displayed on a display.
